(19) United States
(12) Patent Application Publication
(10) Pub. No.: US 2013/0286177 A1
(43) Pub. Date: Oct. 31, 2013

(54) LOCALIZED GLASS GLARE REDUCTION

(71) Applicants: William C. Deleeuw, Beaverton, OR (US); David L. Graumann, Portland, OR (US)

(72) Inventors: William C. Deleeuw, Beaverton, OR (US); David L. Graumann, Portland, OR (US)

(21) Appl. No.: 13/976,768

(22) PCT Filed: Dec. 20, 2011
(86) PCT No.: PCT/US11/66041

§ 371 Date: Jun. 27, 2013

(51) Int. Cl. B60R 1/00

(52) U.S. Cl. CPC B60R 1/001
USPC 348/77

(57) ABSTRACT

In some embodiments a processor is to determine a head position of a person, to determine a field of view of the person in response to the determined head position, to identify areas of brightness in the field of view of the person, and to dim the areas of brightness in the field of view of the person in a localized manner (for example, without significantly dimming other areas in the field of view of the person). Other embodiments are described and claimed.

### TECHNICAL FIELD

The inventions generally relate to localized reduction of glare in glass.

### BACKGROUND

In a vehicle environment bright lights often affect a driver's vision and attention. Either during dark driving at night or during the day when driving toward the sun, for example, drivers can often be momentarily blinded by an extremely high contrast between the roadway and bright light sources. In other glass environments a high contrast between light sources and other objects on the other side of the glass can also cause problems (for example, inside a building with glass windows).

Current solutions to these problems in a vehicle environment include in older and less expensive cars a manual rear view mirror adjustment feature that allows a driver to adjst an angle of the rear view mirror so that a secondary less reflective surface is engaged. Current solutions of dealing with these problems occurring in the front windshield of cars include using a sun visor. In newer higher end cars a full rear view mirror dimming capability is currently available. However, such solutions produce a full dimming of the entire field of view. Full dimming of the entire field of view is undesirable, since parts of the scene that should remain visible are dimmed, and may hide important things in the field of view of the driver.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

### DETAILED DESCRIPTION

Some embodiments of the inventions relate to localized reduction of glare in glass.

In some embodiments local glare reduction is accomplished in vehicle glass through driver head tracking and Liquid Crystal Display (LCD) filtering.

In some embodiments a processor is to determine a head position of a person, to determine a field of view of the person in response to the determined head position, to identify areas of brightness in the field of view of the person, and to dim the areas of brightness in the field of view of the person in a localized manner (for example, without significantly dimming other areas in the field of view of the person).

In some embodiments, a localized dimming of glass is performed. This is accomplished in some embodiments by identifying a person's head position as well as the person's field of view. In some embodiments, for example, two or more video cameras such as wide angle video cameras are used to identify the person's head position and field of view.

In some embodiments, localized dimming of vehicle glass such as, for example, windshield glass and/or rear view mirror glass is performed. In some embodiments, the head position and field of view of the driver of the vehicle are identified, for example using two or more video cameras (for example, wide angle video cameras).

In some embodiments, computing power is used to perform localized dimming, which provides a significant improvement in safety and ergonomics.

In some embodiments, an estimation of the head position of a person (for example, the driver of a vehicle) is estimated. Positions on glass (for example, vehicle glass, mirrors, etc) are calculated at points where bright lights are perceived by the person. In some embodiments one or more Liquid Crystal Display (LCD) filters or overlays is provided on glass (for example, on a windshield and/or a mirror) in order to dim one or more bright lights without affecting the remainder of the driver's field of view.

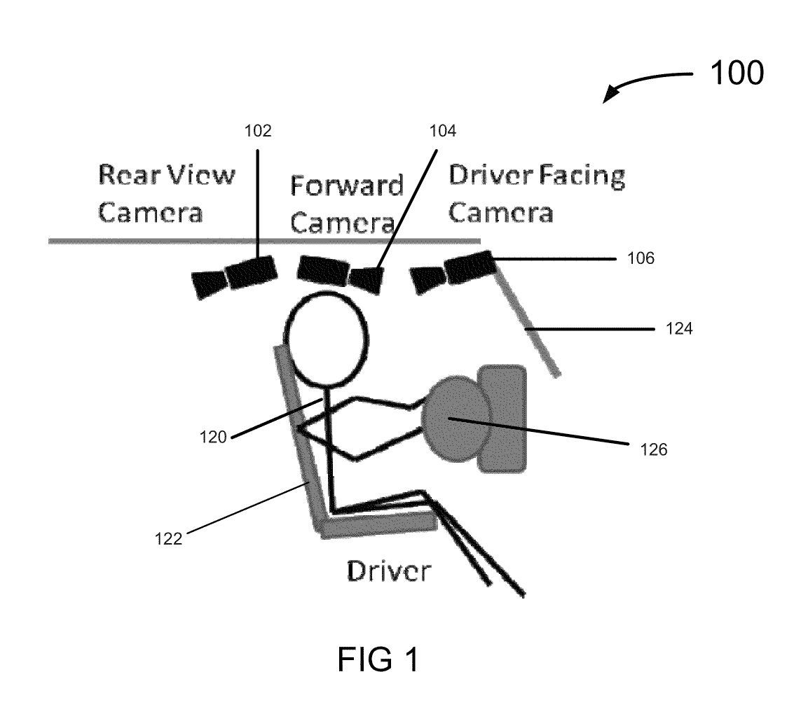

FIG. 1 illustrates a system 100 according to some embodiments of the inventions. In some embodiments, system 100 is in a vehicle environment. System 100 includes in some embodiments a rear view camera 102, a forward camera 104, a driver facing camera 106, a driver 120, a driver vehicle seat 122, a windshield 124, and a steering wheel 126.

In some embodiments, the problem of bright lights affecting the vision and attention of driver 120 is solved. At night when bright lights and/or shine into the eyes of driver 120 through the windshield 124 or the rear view mirror or other mirrors of the vehicle (not illustrated in FIG. 1), system 100 compensates for high contrasts between light sources according to some embodiments. System 100 allows for bright lights to be dimmed in a field of view of driver 120 without significantly affecting the brightness of some other nearby things. This allows the driver 120, for example, to see a poorly illuminated child entering a roadway while headlights from an oncoming vehicle are directed at the eyes of the driver 120.

In some embodiments, driver facing camera 106 captures an image of the driver 120. An on-board computer or processor (not illustrated in FIG. 1) receives the image from camera 106 and is able to estimate the head position of the driver 120 in response to the image. In some embodiments, rear view camera 102 captures a rear view image (for example, a rear view mirror image) field of view. In some embodiments, camera 102 is an in-vehicle wide angle video camera. In some embodiments, forward facing camera 104 captures a front windshield view image field of view (for example, a field of view of driver 120 through windshield 124).

In some embodiments, other camera types may be used as driver cameras and/or viewer facing cameras. For example, in some embodiments an infrared camera may be used, and/or a dept camera (similar to that used by Kinect) may be used. According to some embodiments, projection of infrared light may be used to illuminate a person's head (for example, a vehicle driver's head) without affecting their vision.

The on vehicle computer analyzes the windshield and mirror fields of view images captures by cameras 102 and 104. The computer determines which portions of those fields of view correspond to the driver's field of view through the windshield 124 and the rear view mirror, for example. This is accomplished by taking into account the driver's head position calculated by the computer in response to the image captured by driver facing camera 106. By establishing which points on the windshield 124 and mirror correspond to overly bright light, the computer (or processor) uses a Liquid Crystal Display on the windshield and/or mirror to selectively reduce brightness in those areas that correspond to overly bright light. In some embodiments, the LCD or LCDs on the windshield and/or mirror are used as a filter to dim localized areas in a driver's field of view that correspond to bright light.

Without dimming, headlights at night can be very bright in a windshield and/or a rear view mirror and possibly even blinding to a driver such as driver 120. Other objects in the driver's field of view through the windshield and/or rear view mirror are fairly dim in comparison to the bright headlights. With existing auto-dimming solutions, an entire rear view mirror is dimmed so that the headlights get dimmer, but other objects get even dimmer than they were before without dimming and can almost completely disappear from the driver's field of vision. In some embodiments, localized dimming is performed so that the area of the headlights in the rear view mirror, for example, are dimmed, allowing the driver to be unblended by the headlights but also still able to see dimmer objects in the rear view mirror (or other window glass of the vehicle). By determining the driver's head position, the portion of the field of view in the rear view mirror is computed, and the area of the mirror (or other glass) responsible for reflecting overly bright lights is identified so that active localized dimming of that area (or areas) is performed.

In some embodiments of FIG. 1, three video cameras may be used. A camera for locating a driver's head within a vehicle cabin, a camera (for example, a wide angle camera) mounted on the rearview mirror and looking out the back window to establish a rear view mirror field of view, and a camera (for example, a wide angle camera) looking forward and mounted near the driver's seat to capture the scene out of the front windshield.

In some embodiments, Liquid Crystal Display (LCD) films are placed on the windshield and on the rear view mirror to allow a computer or processor to perform localized dimming of portions of a driver's field of view.

In some embodiments, a computer (or processor) analyzes video feeds to establish a head position of a driver, and determines the portions of a forward and rearward looking camera's fields of view correspond to the driver's field of view.

In some embodiments, bright lights in a person's field of view may be dimmed in a localized manner without affecting other items in the person's field of view that are not similarly bright.

In some embodiments a person's head position (for example, a driver's head position) is determined and positions on glass where bright lights are perceived to be coming from are calculated. An LCD overlay (or filter) on the glass allows one or more bright lights to be dimmed without affecting the remainder of the person's field of view.

In some embodiments, localized dimming in a glass environment (for example, in a car glass environment such as on a car windshield) may be implemented using an “active visor” rather than as an application on the glass itself (for example, the windshield itself). In some jurisdictions it may be illegal to tint or dim the windshield, for example. Thus, according to some embodiments, a transparent visor is used. A transparent visor with LCD localized dimming addresses this concern and is implemented according to some embodiments.

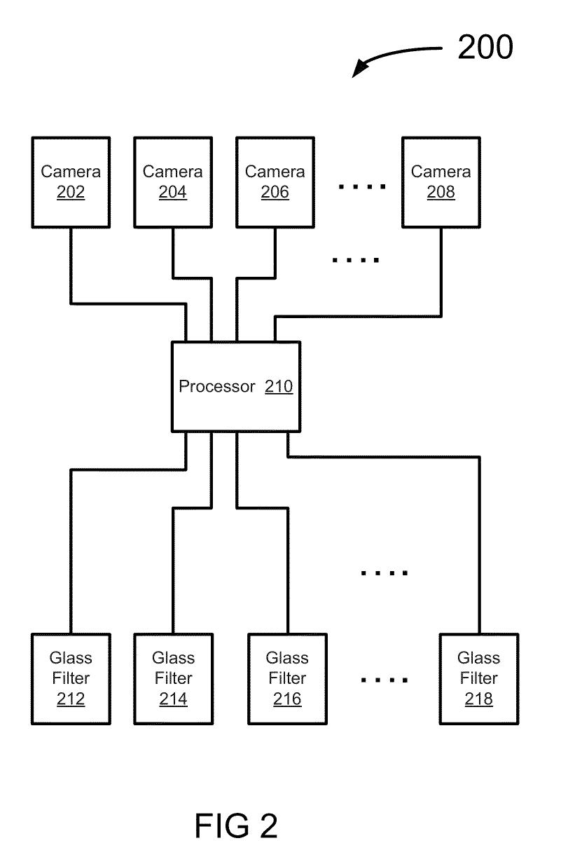

FIG. 2 illustrates a system 200 according to some embodiments. System 200 includes one or more cameras (for example, video cameras and/or wide angle cameras) 202, 204, 206, . . . , 208, a processor (or computer) 210, and one or more glass filters 212, 214, 216, . . . , 218. According to some embodiments, any number of cameras may be included to capture different fields of view of a person (for example, a driver of a vehicle) as well as to capture a head position of the person. According to some embodiments, any number of glass filters may be included to provide a filtering affect in order to dim one or more bright lights in one or more pieces of glass that are in a field of view of the person. In some embodiments, the one or more glass filters are LCD overlays and/or provide LCD dimming in a selective and/or localized manner.

According to some embodiments, processor or computer 210 determines a person's head position in response to one or more images from one or more of the cameras. In some embodiments, processor or computer 210 analyzes field of view images from one or more of the cameras and determines portions of fields of view of a person through glass based on the person's head position. In some embodiments, the computer controls one or more glass filters to selectively and/or locally reduce brightness from areas corresponding to overly bright light in the field of view of the person through portions of glass (for example, glass, mirrors, vehicle glass, vehicle mirrors, etc).

In some embodiments, the field of view of the person changes as the person turns their head. Therefore, according to some embodiments, several different fields of view and/or glass filters may be used, and fields of view and glass through which the fields of view are viewed dynamically change over time. Therefore, in some embodiments, glass (such as a windshield) may be in the field of view at one time (for example, while the person is looking through the windshield) but not at other times (for example, when the person turns their head to look through another glass (for example, a side window of a vehicle during a turn or a rear window of a vehicle while backing up).

Although some embodiments have been described herein as being implemented in a vehicle environment, a rear view mirror environment and/or a front windshield environment, according to some embodiments these particular implementations may not be required. For example, similar implementations of the present inventions occur in any glass areas of a vehicle, and are not even limited to vehicles. For example, similar implementations also occur in other glass environments. For example, in some embodiments, similar implementations occur in rear view mirrors, side mirrors, back windows, side windows, etc. of a vehicle, and similar implementations occur in home glass environments, commercial glass environments, office glass environments, etc.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a processor to determine a head position of a person, to determine a field of view of the person in response to the determined head position, to identify areas of brightness in the field of view of the person, and to dim the areas of brightness in the field of view of the person in a localized manner.

2. The apparatus of claim 1, further comprising a camera to provide an image of a head of the person, the processor to determine the head position of the person in response to the provided image of the head of the person.

3. The apparatus of claim 2, wherein the camera is a video camera and the provided image of the head of the person is a video image.

4. The apparatus of claim 1, further comprising a camera to provide a possible field of view of the person looking into or through glass, the processor to determine the field of view of the person in response to the deter mined head position and in response to the possible field of view of the person into or through glass.

5. The apparatus of claim 4, wherein the camera is a video camera.

6. The apparatus of claim 1, further comprising:
a first camera to provide an image of a head of the person, the processor to determine the head position of the person in response to the provided image of the head of the person; and
a second camera to provide a possible field of view of the person into or through glass, the processor to determine the field of view of the person in response to the determined head position and in response to the possible field of view of the person into or through glass.

7. The apparatus of claim 1, further comprising a glass filter, the processor to dim the areas of brightness in the field of view of the person in a localized manner by controlling the glass filter.

8. The apparatus of claim 7, wherein the glass filter comprises a Liquid Crystal Display filter.

9. The apparatus of claim 7, wherein the glass filter comprises a Liquid Crystal Display overlay.

10. The apparatus of claim 1, wherein the person is a driver of a vehicle.

11. The apparatus of claim 1, wherein the field of view of the person is into or through glass.

12. The apparatus of claim 11, wherein the glass is a mirror.

13. The apparatus of claim 1, the processor to dim the areas of brightness in the field of view of the person without significantly dimming other areas in the field of view of the person.

14. The apparatus of claim 1, further comprising a transparent visor, the processor to control the transparent visor to dim the areas of brightness in the field of view of the person in a localized manner.

15. A method comprising:
determining a head position of a person;
determining a field of view of the person in response to the determined head position;
identifying areas of brightness in the field of view of the person;
dimming the areas of brightness in the field of view of the person in a localized manner.

16. The method of claim 15, providing an image of a head of the person and determining the head position of the person in response to the provided image of the head of the person.

17. The method of claim 16, wherein the provided image of the head of the person is a video image.

18. The method of claim 15, providing an image corresponding to a possible field of view of the person looking into or through glass, and determining the field of view of the person in response to the determined head position and in response to the possible field of view of the person into or through glass.

19. The method of claim 18, wherein the image is a video image.

20. The method of claim 15, further comprising:
providing an image of a head of the person;
determining the head position of the person in response to the provided image of the head of the person;
providing an image corresponding to a possible field of view of the person into or through glass;
determining the field of view of the person in response to the determined head position and in response to the possible field of view of the person into or through glass.

21. The method of claim 15, further comprising controlling a glass filter to dim the areas of brightness in the field of view of the person in a localized manner.

22. The method of claim 21, wherein the glass filter comprises a Liquid Crystal Display filter.

23. The method of claim 21, wherein the glass filter comprises a Liquid Crystal Display overlay.

24. The method of claim 15, wherein the person is a driver of a vehicle.

25. The method of claim 15, wherein the field of view of the person is into or through glass.

26. The method of claim 25, wherein the glass is a mirror.

27. The method of claim 15, further comprising dimming the areas of brightness in the field of view of the person without significantly dimming other areas in the field of view of the person.

28. The method of claim 15, further comprising controlling a transparent visor to dim the areas of brightness in the field of view of the person in a localized manner.
